(19) United States
(12) Patent Application Publication
(10) Pub. No.: US 2011/0007063 A1
(43) Pub. Date: Jan. 13, 2011

(54) DRIVING CIRCUIT AND DRIVING METHOD

(75) Inventor: Satoru MATSUDA, Kanagawa (JP)

Correspondence Address: YOUNG & THOMPSON, 209 Madison Street, Suite 500, Alexandria, VA, 22314, US

(73) Assignee: RENESAS ELECTRONICS CORPORATION, Kawasaki-shi (JP)

(21) Appl. No.: 12/825,871

(22) Filed: Jun. 29, 2010

(30) Foreign Application Priority Data
Jul. 7, 2009 (JP) 2009-160781

(51) Int. Cl. G09G 5/00

(52) U.S. Cl. 345/213; 345/204

(57) ABSTRACT

A driving circuit includes: output buffers provided to drive first and second groups of data lines, which are connected with pixels of a display panel, with drive voltage signals supplied to input terminals of the output buffers, respectively; first and second common portions; and a first short-circuiting section provided for each of the data lines of the first group to connect the input terminal of a corresponding one of the output buffers for the first group of data lines to the first common portion in response to a first connection control signal. A second short-circuiting section is provided for each of the data lines of the second group to connect the input terminal of a corresponding one of the output buffers for the second group of data lines to the second common portion in response to a second connection control signal.

### INCORPORATION BY REFERENCE

This patent application claims a priority on convention based on Japanese Patent Application No. 2009-160781 filed on Jul. 7, 2009. The disclosure thereof is incorporated herein by reference.

### TECHNICAL FIELD

The present invention relates to an LCD (Liquid Crystal Display) driving circuit.

### BACKGROUND ART

An LCD (Liquid Crystal Display) driving circuit is required to cope with the increase in the number of pixels in an HD-TV (High Definition Television) and a personal computer (hereafter, to be referred to as a PC) and the higher resolution. Also, in addition to the above, the LCD driving circuit is required to display a video image without any blurring display phenomenon peculiar to the LCD display. For this reason, a time during which the LCD driving circuit writes a data in one pixel becomes shorter every year. A frame rate becomes faster, from 60 Hz to 120 Hz and 240 Hz. In this way, for the LCD driving circuit, the higher speed of switching is required. However, when there is a time (a high impedance time) during which a pixel load is not driven by an output amplifier of the LCD driving circuit, the effective drive time becomes shorter, so that the higher speed of the switching cannot be attained.

A patent literature 1 discloses a driving circuit in which, while the increase in a chip area is suppressed to a necessary minimum, the output delay time of a drive voltage can be reduced, and the higher speed and the small power consumption amount can be attained.

A driving circuit in patent literature 1 will be described below with reference to FIGS. 1 to 3. FIG. 1 is a circuit block diagram showing the configuration of the driving circuit in the patent literature 1.

The driving circuit in the patent literature 1 includes a digital-to-analog (D/A) converter 40 and an output circuit 50. The D/A converter 40 generates positive and negative driving signals, which are applied to liquid crystal elements in an LCD panel, on the basis of an image data supplied from a circuit at a former stage (not shown). The output circuit 50 switches the polarities of the driving signals, which are supplied from the D/A converter 40, for each column line. Here, the image data is generated by using a well-known technique and then supplied to the D/A converter 40. Thus, the description is omitted.

The D/A converter 40 includes resistor arrays 41 ad 42 and a plurality of selectors 43-1 to 43-4. It should be noted that FIG. 1 shows a part of the D/A converter 40 in order to simplify the description. The D/A converter 40 includes the selectors for the number of column lines to be driven. For example, when the 384 column lines are driven, the D/A converter 40 has the 384 selectors.

The resistor arrays 41 and 42 are the resistor arrays for generating the positive and negative drive voltages, respectively. Each of the resistor arrays 41 and 42 is provided with, for example, 63 resistance elements connected in series. Gamma correction reference voltages GMA1 and GMA5 are applied to the resistor array 41, and Gamma compensation reference voltages GMA6 and GMA10 are applied to the resistor array 42. Here, the reference voltages GMA1 and GMA5 are for the positive drive voltages, and the reference voltages GMA6 and GMA10 are for the negative drive voltages. The resistor array 41 generates 64-level voltages in accordance with the reference voltages GMA1 and GMA5. The resistor array 41 outputs the generated 64-level voltages to the selectors 43-1 and 43-3. Also, the resistor array 42 generates 64-level voltages in accordance with the reference voltages GMA6 and GMA10. The resistor array 42 outputs the generated 64-level voltages to the selectors 43-2 and 43-4.

The selectors 43-1 to 43-4 receive 6-bit image data from a circuit at the former stage (not shown), respectively. Each of the selectors 43-1 and 43-3 selects one from the 64-level positive voltages supplied from the resistor array 41 in accordance with the image data. The selector 43-1 is connected to switches 53-1 and 53-2 in the output circuit 50. The selector 43-1 outputs the selected voltage as the positive drive voltage to the switches 53-1 and 53-2. The selector 43-3 is connected to switches 53-3 and 53-4 in the output circuit 50. The selector 43-3 outputs the selected voltage as the positive drive voltage to the switches 53-3 and 53-4. Also, each of the selectors 43-2 and 43-4 selects one from the 64-level negative reference voltages supplied from the resistor array 42. The selector 43-2 is connected to the switches 53-1 and 53-2 in the output circuit 50. The selector 43-2 outputs the selected voltage as the negative drive voltage to the switches 53-1 and 53-2. The selector 43-4 is connected to the switches 53-3 and 53-4 in the output circuit 50. The selector 43-4 outputs the selected voltage as the negative drive voltage to the switches 53-3 and 53-4.

It should be noted that the positive and negative polarities do not imply that the voltage of the signal is higher or lower than a ground voltage GND. The positive and negative polarities imply that they are higher or lower than the voltage of the common electrode of each of the liquid crystal elements in the LCD panel. For example, when the common electrode of the liquid crystal element is set to Vdd/2, the polarity of the drive voltage higher than Vdd/2 is referred to as a positive polarity, and oppositely the polarity of the drive voltage lower than Vdd/2 is referred to as a negative polarity.

The output circuit 50 includes output buffers 52-1 to 52-4, the switches 53-1 to 53-4 and switches 54-1 to 54-4. It should be noted that FIG. 1 shows a part of the output circuit 50 in order to simplify the description. The output circuit 50 includes the output buffers for the number of column lines to be driven and the respective switches of two kinds. For example, when the 384 column lines are driven, the output circuit 50 includes the 384 output buffers and the respective switches.

Each of the switches 53-1 and 53-2 is connected to the selectors 43-1 and 43-2 to receive the positive drive voltage and the negative drive voltage from the selectors 43-1 and 43-2. Similarly, each of the switches 53-3 and 53-4 is connected to the selectors 43-3 and 43-4, to receive the positive drive voltage and the negative drive voltage from the selectors 43-3 and 43-4.

Each of the switches 53-1 to 53-4 switches a connection destination between the selectors 43-1 and 43-2 on the basis of a polarity selection signal SEL. The polarity selection signal SEL changes between a high level and a low level for each horizontal display period of the LCD panel which is determined based on a switching control signal TP1. The switches 53-1 to 53-4 output to the switches 54-1 to 54-4, the drive voltages, which are selected by switching the polarities for each horizontal display period.

FIG. 2 shows three states that can be selected by each of the switches 53-1 to 53-4 in the patent literature 1. Each switch can take any of the three states of “ON1”, “OFF” and “ON2”. When each switch is in the “ON1” state or in the “ON2” state, the switch is connected to the positive drive voltage or the negative drive voltage and outputs the connected voltage to the output terminal. On the other hand, when the switch is in the OFF state, the switch is not connected to any selector, and holds the output terminal in a high impedance state.

The switches 54-1 to 54-4 are connected to a common signal line COM. Since the switches 54-1 to 54-4 are turned on in accordance with a short-circuit control signal SHORT, the input terminals of the output buffers 52-1 to 52-4 are short-circuited to the common signal line COM. In the driving circuit in the patent literature 1, when the switches 53-1 to 53-4 are in the OFF state, the switches 54-1 to 54-4 are turned on, and the input terminals of the output buffers 52-1 to 52-4 are short-circuited to the common signal line COM.

That is, when the switches 53-1 to 53-4 are in the “ON1” or “ON2” state, the switches 54-1 to 54-4 are in the OFF state. Thus, the output buffers 52-1 to 52-4 receive the positive or negative drive voltages from the switches 53-1 to 53-4 and output to the column lines. On the other hand, when the switches 53-1 to 53-4 are in the OFF state, the switches 54-1 to 54-4 are in the ON state. Thus, through the switches 54-1 to 54-4, the output buffers 52-1 to 52-4 are connected to the common signal line COM in common. Therefore, the re-distribution of electric charges is carried out for the output buffers 52-1 to 52-4.

The operation of the driving circuit in the patent literature 1 will be described below with reference to FIG. 3. FIG. 3 shows timing charts in the operation of the driving circuit in the patent literature 1.

A switching control signal TP1 as a pulse signal is shown in (a) to have a horizontal display period (H). 6-bit image data D0 to D5 supplied to one of the selectors 43-1 to 43-4 is shown in (b). The image data is latched at the falling edge of the switching control signal TP1. A polarity selection signal SEL is shown in (c) which is changed in synchronization with the switching control signal TP1. The signal level of the polarity selection signal SEL is switched between a high level and a low level for every horizontal display period. The switches 53-1 to 53-4 are controlled in accordance with the switching control signal TP1 and the polarity selection signal SEL. The switches 53-1 to 53-4 are in the OFF state while the TP1 is the high level. Also, the short-circuit control signal SHORT is shown in (d), which is held in the high level while the TP1 is the high level. The switches 54-1 to 54-4 are held in the ON state while the short-circuit control signal SHORT is the high level, so that the output buffers 52-1 to 52-4 are connected to the common signal line COM. Output signals of the switches 53-1 and 53-2 are respectively shown in (e) and (f). Also, a part of (f) of FIG. 3 is enlarged in (g).

For example, it is assumed that a drive voltage outputted from the switch 53-2 is switched from the negative drive voltage GMA10 to the positive drive voltage GMA1. In response to the high level of the short-circuit control signal SHORT, the switches 54-1 to 54-4 are turned on. At this time, the switches 53-1 to 53-4 are in the OFF state, and the input terminals of the output buffers 52-1 to 52-4 are connected to the common signal line COM, to carry out the re-distribution of the electric charges. As a result, the input terminals of the output buffers 52-1 to 52-4 have a voltage level close to a middle voltage. The middle voltage implies a reference voltage GMA5 or GMA6 or the voltage close thereto. Then, when the TP1 becomes the low level, the switch 54-2 is turned off. Simultaneously, since the polarity selection signal SEL is set to the high level, the switch 53-2 is switched to the positive drive voltage GMA1.

In this way, according to the driving circuit in the patent literature 1, before the polarity of the drive voltage is switched, the input terminals of all the output buffers 52-1 to 52-4 are connected to the common signal line COM and short-circuited. Thus, the input terminals of the output buffers 52-1 to 52-4 are held at the substantially middle voltage between the maximum voltage and the minimum value of the drive voltage. Since the inputs of the output buffers 52-1 to 52-4 are switched from the middle voltage to the target drive voltage, the fast drive characteristic can be attained in a small power consumption amount.

### Citation List

Patent literature 1: JP 2001-255857A

### SUMMARY

In the driving circuit in the patent literature 1, the switches 53-1 to 53-4 have the three states. When the switches 53-1 to 53-4 are in the OFF state, the input signals of the output buffers 52-1 to 52-4 are in the high impedance states. In those states, the output buffers 52-1 to 52-4 cannot be driven with the drive voltages. Thus, a waste is generated in the drive times of the output buffers 52-1 to 52-4.

This is because in the D/A converter 40, the common signal line COM is single although there are the two kinds of the positive drive voltages and the negative drive voltages. Typically, when the drive voltages outputted from the D/A converter 40 are assumed to be in a range between VDD2 and VSS, the positive polarity breakdown voltage of the D/A converter is between about VDD2 and (½)VDD2, and the negative polarity breakdown voltage of the D/A converter is between about (½)VDD2 and VSS. Thus, when the switches 54-1 to 54-4 are in the ON state and the switches 53-1 to 53-4 are set to the ON1 state or the ON2 state, the positive and negative drive voltages from the D/A converter 40 are short-circuited, and they exceeds both of the breakdown voltages. In order to avoid this, when the switches 54-1 to 54-4 are in the ON state, the switches 53-1 to 53-4 are required to be turned off, and the input terminals of the output buffers 52-1 to 52-4 are required to be in the high impedance states. Therefore, the three states are required in the switches 53-1 to 53-4.

In an aspect of the present invention, a driving circuit includes: output buffers provided to drive first and second groups of data lines, which are connected with pixels of a display panel, with drive voltage signals supplied to input terminals of the output buffers, respectively; first and second common portions; a first short-circuiting section provided for each of the data lines of the first group to connect the input terminal of a corresponding one of the output buffers for the first group of data lines to the first common portion in response to a first connection control signal; and a second short-circuiting section provided for each of the data lines of the second group to connect the input terminal of a corresponding one of the output buffers for the second group of data lines to the second common portion in response to a second connection control signal.

In another aspect of the present invention, a driving method is achieved by driving by output buffers, first and second groups of data lines, which are connected with pixels of a display panel, with drive voltage signals supplied to input terminals of the output buffers, respectively; by connecting the input terminal of each of the output buffers for the first group of data lines to a first common portion in response to a first connection control signal; and by connecting the input terminal of each of the output buffers for the second group of data lines to a second common portion in response to a second connection control signal.

According to the present invention, the driving circuit can be provided in which the input terminal of the output buffer in the output circuit is not set to the high impedance. Thus, the output circuit can always supply the drive voltage to the output buffer, and the drive time of the output buffer can be reduced, and the output delay of the output buffer can be improved.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a view showing the configuration of a driving circuit shown in patent literature 1;

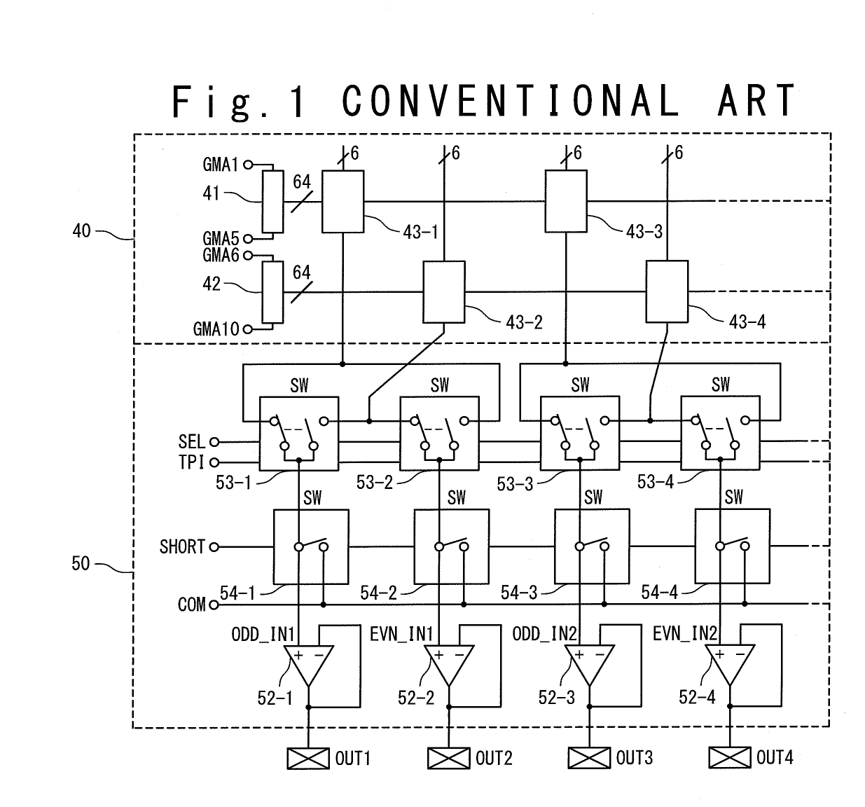

FIG. 2 shows the three states of switches 53-1 to 53-4 shown in FIG. 1;

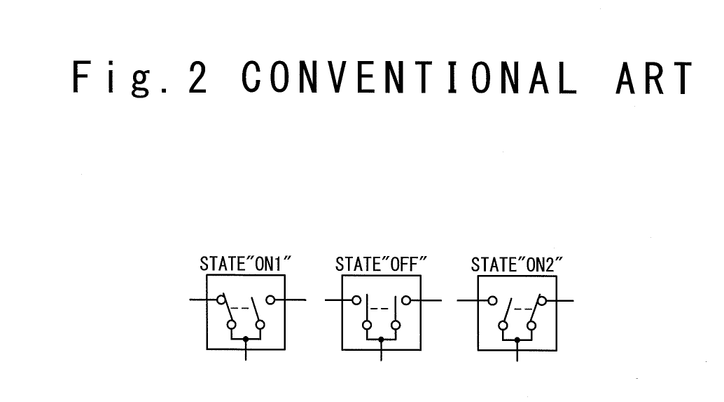

FIG. 3 shows timing charts showing an operation method of the driving circuit in the patent literature 1;

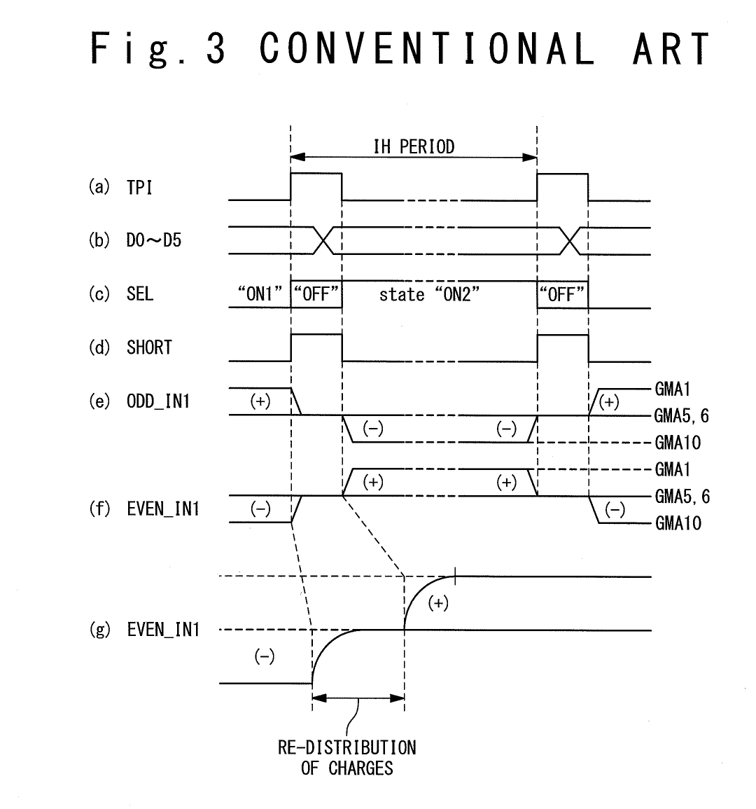

FIG. 4 is a circuit block diagram showing a configuration of a driving circuit according to a first embodiment of the present invention;

FIG. 5 shows timing charts in an operation method of the driving circuit in the first embodiment;

FIG. 6 is a circuit block diagram showing a configuration of the driving circuit according to a second embodiment of the present invention; and

FIG. 7 shows timing charts in an operation method of the driving circuit in the second embodiment.

### BRIEF DESCRIPTION OF THE PREFERRED EMBODIMENTS

Hereinafter, a driving circuit according to the present invention will be described in detail with reference to the attached drawings. In the following description, the driving circuit of 6 bits will be described. However, the present invention can be applied to the driving circuit of 8 bits or more.

### First Embodiment

At first, the driving circuit according to a first embodiment of the present invention will be described.

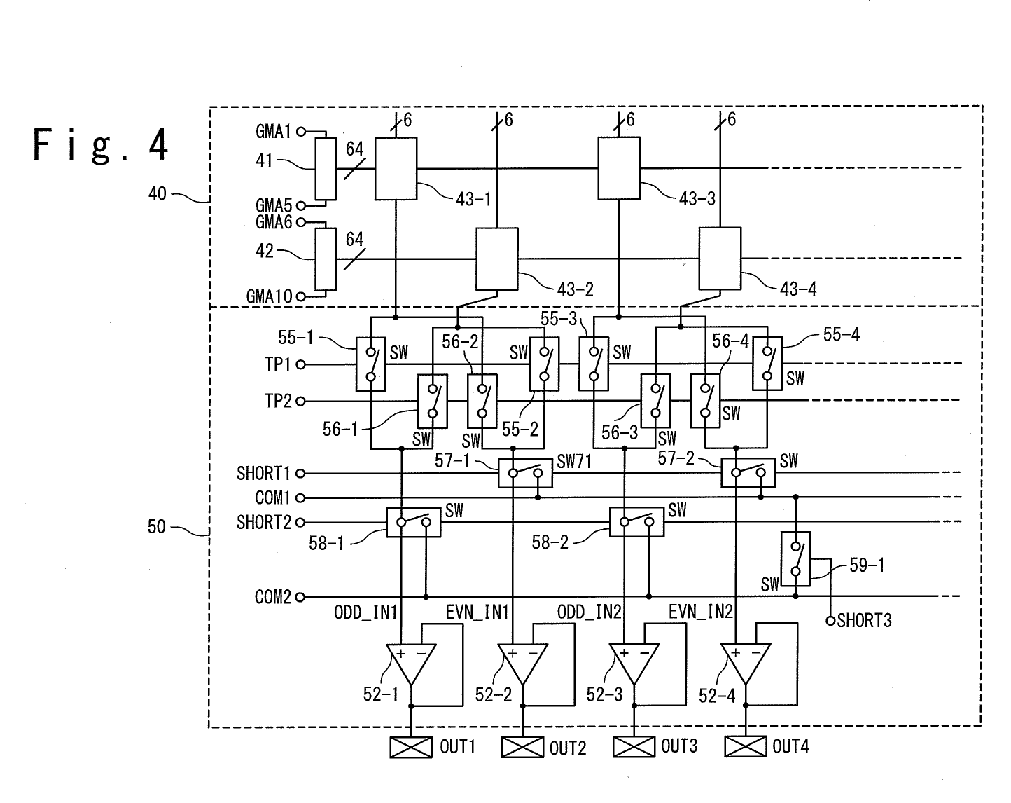

At first, the configuration of the driving circuit in the present embodiment will be described. FIG. 4 is a circuit block diagram showing the configuration of the driving circuit in the present embodiment.

The driving circuit in this embodiment includes a digital-to-analog (D/A) converter 40 and an output circuit 50. The D/A converter 40 generates positive and negative polarity driving signals which are applied to liquid crystal elements in a liquid crystal display (LCD) panel on the basis of the image data supplied from a circuit of a previous stage (not shown). The output circuit 50 switches the polarity of the driving signal supplied from the D/A converter 40 for every column line. Here, since the image data is generated and supplied to the D/A converter 40 as in the conventional example, its detailed description is omitted.

The D/A converter 40 includes resistor arrays 41 and 42 and a plurality of selectors 43-1 to 43-4. It should be noted that FIG. 4 shows only a part of the D/A converter 40 in order to simplify the description. The D/A converter 40 includes the selectors for the number of column lines to be driven.

That is, the resistor array 41 is applied with gamma correction reference voltages GMA1 and GMA5, and generates 64-level gradation voltages in accordance with the reference voltages GMA1 and GMA5. The resistor array 41 outputs the 64-level gradation voltages to the selectors 43-1 and 43-3. Also, the resistor array 42 is applied with gamma correction reference voltages GMA6 and GMA10, and generates 64-level gradation voltages in accordance with the reference voltages GMA6 and GMA10. The resistor array 42 outputs the 64-level gradation voltages to the selectors 43-2 and 43-4. Here, the reference voltages GMA1 and GMA5 are for a positive polarity, and the reference voltages GMA6 and GMA10 are for a negative polarity. It should be noted that the positive and negative polarities do not always imply that the voltage of a signal is higher or lower than the ground voltage GND. The positive and negative polarities imply that they are higher or lower than a voltage of a common electrode of each liquid crystal element in the LCD panel.

Also, the selectors 43-1 to 43-4 are supplied with the image data. Each of the selectors 43-1 to 43-4 selects one from the 64-level gradation voltages in accordance with the image data.

In the selectors 43-1 to 43-4 in this embodiment, its connection relation to the switches contained in the output circuit 50 differs from those of the conventional technique. Each of the selectors 43-1 to 43-4 outputs the selected voltage as the positive or negative drive voltage to switches 55-1 to 55-4 and 56-1 to 56-4. It should be noted that the connection relation between the selectors 43-1 to 43-4 and the switches 55-1 to 55-4 and 56-1 to 56-4 will be described later.

The output circuit 50 includes the output buffers 52-1 to 52-4, the switches 55-1 to 55-4, the switches 56-1 to 56-4, switches 57-1 and 57-2, switches 58-1 and 58-2 and a switch 59-1. It should be noted that FIG. 4 shows a part of the output circuit 50 in order to simplify the description. The output circuit 50 includes output buffers of a number corresponding to the number of column lines to be driven and the respective switches.

The switches 55-1 and 56-2 are connected to the selector 43-1 to receive the positive drive voltage from the selector 43-1. Also, the switches 55-2 and 56-1 are connected to the selector 43-2 to receive the negative drive voltage from the selector 43-2. The switches 55-1 and 55-2 are switched between an ON state and an OFF state in response to a switching control signal TP1. The switches 56-1 and 56-2 are switched between the ON state and the OFF state in response to a switching control signal TP2.

Also, the switches 55-3 and 56-4 are connected to the selector 43-3 to receive the positive drive voltage from the selector 43-3. Also, the switches 55-4 and 56-3 are connected to the selector 43-4 to receive the negative drive voltage from the selector 43-4. The switches 55-3 and 55-4 are switched between the ON state and the OFF state in response to the switching control signal TP1. The switches 56-3 and 56-4 are switched between the ON state and the OFF state in response to the switching control signal TP2.

The switch 58-1 is connected to the switches 55-1 and 56-1, and the output buffer 52-1. The switch 58-1 receives the positive drive voltage from the switch 55-1 or the negative drive voltage from the switch 56-1, and outputs the received voltage to the output buffer 52-1. Also, the switch 58-1 is switched between the ON state and the OFF state in response to a short-circuit control signal SHORT2. The switch 58-1 connects the switches 55-1 and 56-1 to a common signal line COM2 in the ON state. The switch 58-1 disconnects the switches 55-1 and 56-1 from the common signal line COM2 in the OFF state.

The switch 57-1 is connected to the switches 55-2 and 56-2 and the output buffer 52-2. The switch 57-1 receives the positive drive voltage from the switch 56-2 or the negative drive voltage from the switch 55-2 and outputs the received voltage to the output buffer 52-2. Also, the switch 57-1 is switched between the ON state and the OFF state in response to a short-circuit control signal SHORT1. The switch 57-1 connects the switches 55-2 and 56-2 to a common signal line COM1 in the ON state. The switch 57-1 disconnects the switches 55-2 and 56-2 from the common signal line COM1 in the OFF state.

The switch 58-2 is connected to the switches 55-3 and 56-3 and the output buffer 52-3. The switch 58-2 receives the positive drive voltage from the switch 55-3 or the negative drive voltage from the switch 56-3, and outputs the received voltage to the output buffer 52-3. Also, the switch 58-2 is switched between the ON state and the OFF state in response to the short-circuit control signal SHORT2. The switch 58-2 connects the switches 55-3 and 56-3 to the common signal line COM2 in the ON state. The switch 58-2 disconnects the switches 55-3 and 56-3 from the common signal line COM2 in the OFF state.

The switch 57-2 is connected to the switches 55-4 and 56-4, and the output buffer 52-4. The switch 57-2 receives the positive drive voltage from the switch 56-4 or the negative drive voltage from the switch 55-4, and outputs the received voltage to the output buffer 52-4. Also, the switch 57-2 is switched between the ON state and the OFF state in response to the short-circuit control signal SHORT1. The switch 57-2 connects the switches 55-4 and 56-4 to the common signal line COM2 in the ON state. The switch 57-2 disconnects the switches 55-4 and 56-4 from the common signal line COM2 in the OFF state.

When the switches 57-1 and 57-2 are in the ON state, the output buffer 52-2 and the output buffer 52-4 are short-circuited through the common signal line COM1. Thus, the re-distribution of electric charges can be carried out between the output buffer 52-2 and the output buffer 52-4.

Also, when the switches 58-1 and 58-2 are in the ON state, the output buffer 52-1 and the output buffer 52-3 are short-circuited through the common signal line COM2. Thus, the re-distribution of electric charges can be carried out between the output buffer 52-1 and the output buffer 52-3.

The switch 59-1 is connected to the common signal lines COM1 and COM2. The switch 59-1 is switched between the ON state and the OFF state in response to a short-circuit control signal SHORT3. The switch 59-1 connects the common signal lines COM1 and COM2 in the ON state. The switch 59-1 disconnects the common signal lines COM1 and COM2 from each other in the OFF state.

The switch 59-1 is shifted to the ON state when the switches 57-1, 57-2, 58-1 and 58-2 are in the ON state. In the ON state, the switch 59-1 connects the common signal lines COM1 and COM2, thereby short-circuiting the output buffers 52-1 to 52-4. Thus, the re-distribution of electric charges can be carried out between the output buffers 52-1 to 52-4.

The output buffers 52-1 to 52-4 are driven with the drive voltages and output the drive voltages to outputs OUT1 to OUT4, respectively.

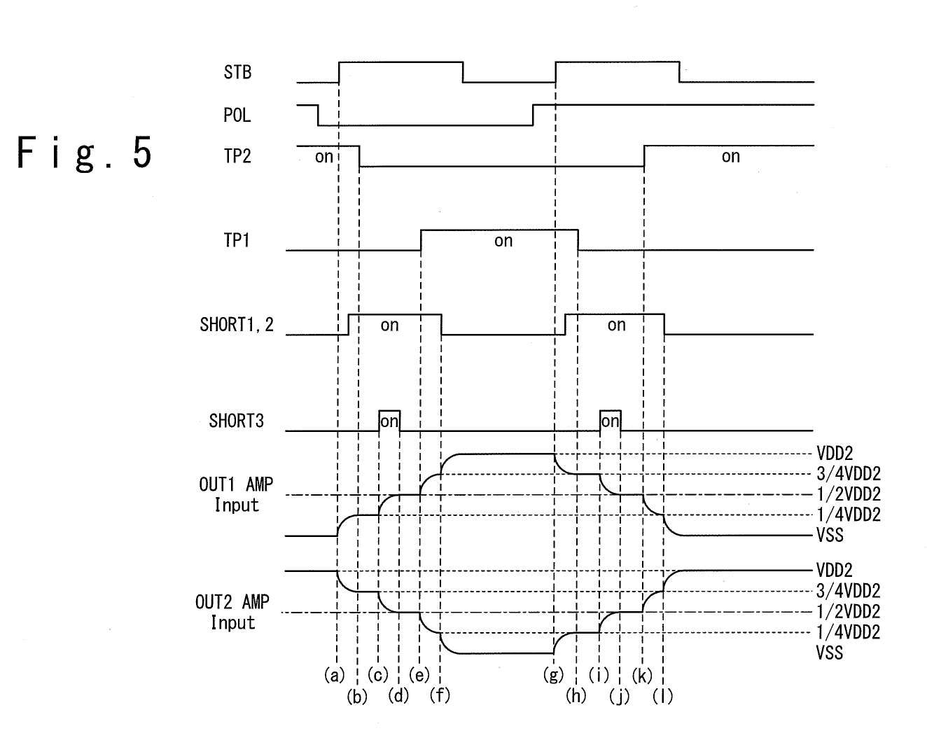

An operation method of the driving circuit in this embodiment will be described below. FIG. 5 shows timing charts in the operation method of the driving circuit in this embodiment.

In FIG. 5, a polarity control signal POL is a signal for controlling the polarity of the voltage applied to the output buffer. In response to the inversion of the polarity control signal POL, the output of each output buffer is inverted. A strobe signal STB is a signal for controlling the transfer of image data from an image LSI (not shown) to the D/A converter 40. The switching control signal TP1 is a signal for controlling the switches 55-1 to 55-4, and the switching control signal TP2 is a signal for controlling the switches 56-1 to 56-4. Also, the short-circuit control signal SHORT1 is a signal for controlling the switches 57-1 and 57-2, and the short-circuit control signal SHORT2 is a signal for controlling the switches 58-1 and 58-2. The short-circuit control signal SHORT3 is a signal for controlling the switch 59-1. A symbol OUT1 AMP INPUT indicates a drive voltage applied to the input terminal of the output buffer 52-1. A symbol OUT2 AMP INPUT indicates a drive voltage applied to the input terminal of the output buffer 52-2.

A case is assumed that the output buffer 52-1 is driven from the negative drive voltage GMA10 to the positive drive voltage GMA1. Also, simultaneously, a case is assumed that the output buffer 52-1 and the output buffer 52-2 are driven from the positive drive voltage GMA10 to the negative drive voltage GMA1. It should be noted that the description will be given under an assumption of GMA1 VDD2 and GMA10 VSS.

In the initial state, it is assumed that the output buffer 52-1 is connected through the switch 56-1 to the selector 43-2 and driven with the negative drive voltage (GMA10 VSS). At this time, the switching control signal TP1 is in the low level, and the switches 55-1 to 55-4 are in the OFF state. The switching control signal TP2 is in the high level, and the switches 56-1 to 56-4 are in the ON state. Also, all of the short-circuit control signals SHORT1 to SHORT3 are in the low level, and all of the switches 57-1, 57-2, 58-1, 58-2, and 59-1 are in the OFF state.

At first, if the polarity control signal POL is inverted, the strobe signal STB is transited to a high level at (a) of FIG. 5, and the sending of the image data to the D/A converter 40 is started. When the strobe signal STB is transited to the high level, the short-circuit control signals SHORT1 and SHORT2 are changed to the high level, and the switches 57-1, 57-2, 58-1, and 58-2 are turned on. At this time, the switching control signal TP1 is still in the low level, and the switches 55-1 to 55-4 are in the OFF state. The switching control signal TP2 is still in the high level, and the switches 56-1 to 56-4 are in the ON state. Also, the short-circuit control signal SHORT3 is still in the low level, and the switch 59-1 is in the OFF state.

Since the switches 58-1 and 58-2 are turned on, the input terminals of the output buffers 52-1 and 52-3 to which the negative drive voltages are supplied are short-circuited. Although the description is omitted, the input terminals of the output buffers to which the negative drive voltages are supplied are similarly short-circuited. In this way, since the negative drive voltages from the D/A converter 40 are connected to the common signal line COM2, the voltage of the common signal line COM2 is approximate to the voltage (¼)VDD2. Thus, the output buffers 52-1 and 52-3 are driven with the voltage (¼)VDD2.

Also, since the switches 57-1 and 57-2 are turned on, the input terminals of the output buffers 52-2 and 52-4 to which the positive drive voltages are supplied are short-circuited. Although the description is omitted, the input terminals of the output buffers to which the positive drive voltages are supplied are similarly short-circuited. In this way, since the positive drive voltages from the D/A converter 40 are connected to the common signal line COM1, the voltage of the common signal line COM1 is approximate to the voltage (¾)VDD2. Thus, the output buffers 52-2 and 52-4 are driven with the voltage (¾)VDD2.

Next, at (b) of FIG. 5, the switching control signal TP2 is set to the low level, and the switches 56-1 to 56-4 are turned off. At this time, the switching control signal TP1 is still in the low level, and the switches 55-1 to 55-4 are in the OFF state. The short-circuit control signals SHORT1 and SHORT2 are still in the high level, so that the switches 57-1, 57-2, 58-1, and 58-2 are in the ON state. Also, the short-circuit control signal SHORT3 is still in the low level, so that the switch 59-1 is the OFF state.

In this state, the common signal line COM2 still approximately holds the voltage (¼)VDD2. Also, the common signal line COM1 still approximately holds the voltage (¾)VDD2. Thus, the output buffers 52-1 and 52-3 are driven with the voltage (¼)VDD2, and the output buffers 52-2 and 52-4 are driven with the voltage (¾)VDD2.

Next, at (c) of FIG. 5, the short-circuit control signal SHORT3 becomes the high level, and the switch 59-1 is turned the ON state. At this time, the switching control signal TP2 is in the low level, and the switches 56-1 to 56-4 are in the OFF state. The short-circuit control signals SHORT1 and SHORT2 are still in the high level, and the switches 57-1, 57-2, 58-1, and 58-2 are in the ON state.

Since the switch 59-1 is turned on, the common signal lines COM1 and COM2 are connected. Thus, the input terminals of the output buffers 52-1 to 52-4 are short-circuited. In this way, since the common signal lines COM1 and COM2 are connected, the common signal lines COM1 and COM2 approximately have the voltage (½)VDD2. Therefore, the output buffers 52-1 to 52-4 are driven with the voltage (½)VDD2.

Next, at (d) of FIG. 5, the short-circuit control signal SHORT3 becomes the low level, and the switch 59-1 is turned off. At this time, the switching control signal TP2 is still in the low level, so that the switches 56-1 to 56-4 are in the OFF state. The switching control signal TP1 is still in the low level, so that the switches 55-1 to 55-4 are the OFF state. The short-circuit control signals SHORT1 and SHORT2 are still in the high level, so that the switches 57-1, 57-2, 58-1, and 58-2 are in the ON state.

In this state, the common signal lines COM1 and COM2 still approximately hold the voltage (½)VDD2. Thus, the output buffers 52-1 to 52-4 are driven with the voltage (½)VDD2.

Next, at (e) of FIG. 5, the switching control signal TP1 is set to the high level, so that the switches 55-1 to 55-4 are turned on. At this time, the switching control signal TP2 is still in the low level, so that the switches 56-1 to 56-4 are in the OFF state. The short-circuit control signals SHORT1 and SHORT2 are still in the high level, so that the switches 57-1, 57-2, 58-1, and 58-2 are in the ON state. Also, the short-circuit control signal SHORT3 is the low level, so that the switch 59-1 is in the OFF state.

In this state, the output buffer 52-1 is connected through the switch 55-1 to the selector 43-1, so that the positive drive voltage is supplied. Also, the output buffer 52-2 is connected through the switch 55-2 to the selector 43-2, so that the negative drive voltage is supplied. At this time, the switches 57-1, 57-2, 58-1, and 58-2 are in the ON state. Thus, the output buffers 52-1 and 52-3 are short-circuited through the common signal line COM2. Thus, the voltage of the common signal line COM2 approximately becomes the voltage (¾)VDD2. The input terminal of the output buffer 52-1 is driven with the voltage (¾)VDD2. Similarly, at this time, the switches 57-1 and 57-2 are in the ON state. Thus, the output buffers 52-2 and 52-4 are short-circuited through the common signal line COM1. Therefore, the common signal line COM1 approximately has the voltage (¼)VDD2. The input terminal of the output buffer 52-2 is driven with the voltage (¼)VDD2.

Next, at (f) of FIG. 5, the short-circuit control signals SHORT1 and SHORT2 are set to the low level, and the switches 57-1 and 57-2 and the switches 58-1 and 58-2 are turned off. At this time, the switching control signal TP1 is still in the high level, and the switches 55-1 to 55-4 are in the ON state. The switching control signal TP2 is still in the low level, and the switches 56-1 to 56-4 are in the OFF state. The short-circuit control signal SHORT3 is in the low level, and the switch 59-1 is in the OFF state.

In this state, the output buffer 52-1 is connected through the switch 55-1 to the selector 43-1 and receives the positive drive voltage. Since the switch 58-1 is turned off, the output buffer 52-1 is driven with VDD2 that is the positive drive voltage from the selector 43-1. Also, the output buffer 52-2 is connected through the switch 55-2 to the selector 43-2 and receives the negative drive voltage. Since the switch 57-1 is turned off, the output buffer 52-2 is driven with the voltage VSS that is the negative drive voltage from the selector 43-2.

In this way, the output buffer 52-1 is driven from the negative drive voltage to the positive drive voltage, and the output buffer 52-2 is driven from the positive drive voltage to the negative drive voltage. After that, when the polarity control signal POL is inverted and the strobe signal STB is again transited to the high level, the polarity inversions of the drive voltages of the respective output buffers are started.

At first, when the polarity control signal POL is inverted, at (g) of FIG. 5, the strobe signal STB is transited to the high level, and the transmission of the image data to the D/A converter 40 is started. After the strobe signal STB becomes the high level, the short-circuit control signals SHORT1 and SHORT2 become the high level, and the switches 57-1 and 57-2, 58-1, and 58-2 are turned on. At this time, the switching control signal TP1 is still in the high level, and the switches 55-1 to 55-4 are in the ON state. The switching control signal TP2 is still in the low level, and the switches 56-1 to 56-4 are in the OFF state. Also, the short-circuit control signal SHORT3 is still in the low level, and the switch 59-1 is in the OFF state.

Since the switches 58-1 and 58-2 are turned on, the input terminals of the output buffers to which the positive drive voltages are supplied are short-circuited. In short, the input terminals of the output buffers 52-1 and 52-3 are short-circuited. In this way, since the positive drive voltages from the D/A converter 40 are connected to the common signal line COM2, the common signal line COM2 approximately has the voltage (¾)VDD2. Thus, the output buffers 52-1 and 52-3 are driven with the voltage (¾)VDD2.

Also, since the switches 57-1 and 57-2 are turned on, the input terminals of the output buffers to which the negative drive voltages are supplied are short-circuited. In short, the input terminals of the output buffers 52-2 and 52-4 are short-circuited. In this way, since the negative drive voltages from the D/A converter 40 are connected to the common signal line COM1, the common signal line COM1 approximately has the voltage (¼)VDD2. Thus, the output buffers 52-2 and 52-4 are driven with the voltage (¼)VDD2.

Next, at (h) of FIG. 5, the switching control signal TP1 is set to the low level, and the switches 55-1 to 55-4 are turned off. At this time, the switching control signal TP2 is still in the low level, and the switches 56-1 to 56-4 are in the OFF state. The short-circuit control signals SHORT1 and SHORT2 are still in the high level, and the switches 57-1, 57-2, 58-1, and 58-2 are in the ON state. Also, the short-circuit control signal SHORT3 is still in the low level, and the switch 59-1 is in the OFF state.

In this state, the common signal line COM2 still approximately holds the voltage (¾)VDD2. Also, the common signal line COM1 still approximately holds the voltage (¼)VDD2. Thus, the output buffers 52-1 and 52-3 are driven with the voltage (¾)VDD2, and the output buffers 52-2 and 52-4 are driven with the voltage (¼)VDD2.

Next, at (i) of FIG. 5, the short-circuit control signal SHORT3 is set to the high level, and the switch 59-1 is turned on. At this time, the switching control signal TP2 is still in the low level, and the switches 56-1 to 56-4 are in the OFF state. The switching control signal TP1 is still in the low level, and the switches 55-1 to 55-4 are in the OFF state. The short-circuit control signals SHORT1 and SHORT2 are still in the high level, and the switches 57-1, 57-2, 58-1, and 58-2 are in the ON state.

Since the switch 59-1 is turned on, the common signal lines COM1 and COM2 are short-circuited. Thus, the input terminals of the output buffers 52-1 to 52-4 are short-circuited. In this way, since the common signal lines COM1 and COM2 are connected, the common signal lines COM1 and COM2 approximately have the voltage (½)VDD2. Therefore, the output buffers 52-1, 52-2 are driven with the voltage (½)VDD2.

Next, at (j) of FIG. 5, the short-circuit control signal SHORT3 is set to the low level, and the switch 59-1 is turned off. At this time, the switching control signal TP2 is still in the low level, and the switches 56-1 to 56-4 are in the OFF state. The short-circuit control signals SHORT1 and SHORT2 are still in the high level, and the switches 57-1, 57-2, 58-1, and 58-2 are in the ON state.

In this state, the common signal lines COM1 and COM2 still approximately hold the voltage (½)VDD2. Thus, the output buffers 52-1 and 52-2 are driven with the voltage (½)VDD2.

Next, at (k) of FIG. 5, the switching control signal TP2 becomes the high level, and the switches 56-1 to 56-4 are turned on. At this time, the switching control signal TP1 is still in the low level, and the switches 55-1 to 55-4 are in the OFF state. The short-circuit control signals SHORT1 and SHORT2 are still in the high level, and the switches 57-1 and 57-2, 58-1, and 58-2 are in the ON state. Also, the short-circuit control signal SHORT3 is low level, and the switch 59-1 is in the OFF state.

In this state, the output buffer 52-1 is connected through the switch 56-1 to the selector 43-2, and the negative drive voltage is supplied. Also, the output buffer 52-2 is connected through the switch 56-2 to the selector 43-1, and the positive drive voltage is supplied. At this time, the switches 58-1 and 58-2 are in the ON state. Thus, the output buffers 52-1 and 52-3 are short-circuited through the common signal line COM2. Therefore, the common signal line COM2 approximately has the voltage (¼)VDD2, and the input terminal of the output buffer 52-1 is driven with the voltage (¼)VDD2. Similarly, at this time, the switches 57-1 and 57-2 are in the ON state. Thus, the output buffers 52-2 and 52-4 are short-circuited through the common signal line COM1. Therefore, the common signal line COM1 approximately has the voltage (¾)VDD2, and the input terminal of the output buffer 52-2 is driven with the voltage (¾)VDD2.

Next, at (l) of FIG. 5, the short-circuit control signals SHORT1 and SHORT2 are set to the low level, and the switches 57-1 and 57-2 and the switches 58-1 and 58-2 are turned off. At this time, the switching control signal TP1 is still in the low level, and the switches 55-1 to 55-4 are in the OFF state. The switching control signal TP2 is still in to the high level, and the switches 56-1 to 56-4 are in the ON state. The short-circuit control signal SHORT3 is the low level, and the switch 59-1 is in the OFF state.

In this state, the output buffer 52-1 is connected through the switch 56-1 to the selector 43-2 and receives the negative drive voltage. Since the switch 58-1 is turned off, the output buffer 52-1 is driven with the voltage VSS that is the negative drive voltage from the selector 43-2. Also, the output buffer 52-2 is connected through the switch 56-2 to the selector 43-1 and receives the positive drive voltage. Since the switch 57-1 is turned off, the output buffer 52-2 is driven with the voltage VDD2 that is the positive drive voltage from the selector 43-1.

In this way, the output buffer 52-1 is driven from the positive drive voltage to the negative drive voltage, and the output buffer 52-2 is driven from the negative drive voltage to the positive drive voltage. After that, when the polarity control signal POL is inverted and the strobe signal STB is again transited to the high level, the polarity inversions of the drive voltages of the respective output buffers are carried out to repeat the above operations (a) to (l).

Until now, the driving circuit in this embodiment has been described. The driving circuit in this embodiment includes the common signal lines COM1 and COM2, through which the input terminals of the output buffers whose polarities (positive, negative) are same are short-circuited. Also, the switch 59-1 is contained through which the common signal lines COM1 and COM2 are connected.

In the above-configured output circuit 50, at first, in the state in which the input terminal of the output buffer is connected to the selector for outputting the positive or negative drive voltage, the input terminal of the output buffer is connected to the common signal line COM1 or COM2, and the input terminals of the output buffers of the same polarity are short-circuited. Next, in the output circuit 50, when the D/A converter 40 is separated in the state in which the input terminals of the respective output buffers are connected to the common signal line COM1 or COM2, the switch 59-1 is turned on to short-circuit the common signal lines COM1 and COM2.

Moreover, in the output circuit 50, in the state in which the input terminal of the output buffer is connected to the common signal line COM1 or COM2, when the switch 59-1 is turned off to open the common signal lines COM1 and COM2, the input terminals of the output buffers are connected to the selectors for outputting the drive voltages of the opposite polarity. In the output circuit 50, in the state in which the input terminals of the output buffers are connected to the selectors for outputting the drive voltages of the opposite polarity, the input terminals of the output buffers are opened from the common signal line COM1 or COM2, and they are driven with the drive voltages supplied from the selectors of the opposite polarity.

In this way, the driving circuit in this embodiment can continuously change the drive voltage without setting the input terminal of the output buffer to the high impedance state. Thus, the drive voltage can be always supplied to the output buffer, and the drive time of the output buffer can be reduced, and the output delay of the output buffer can be improved.

It should be noted that in this embodiment, as mentioned above, FIG. 4 shows only a part of the D/A converter 40 and the output circuit 50. However, the selectors, the switches and the output amplifiers, which are not shown in FIG. 4, are configured and operated similarly to the foregoing descriptions.

### Second Embodiment

The driving circuit according to the second embodiment of the present invention will be described below.

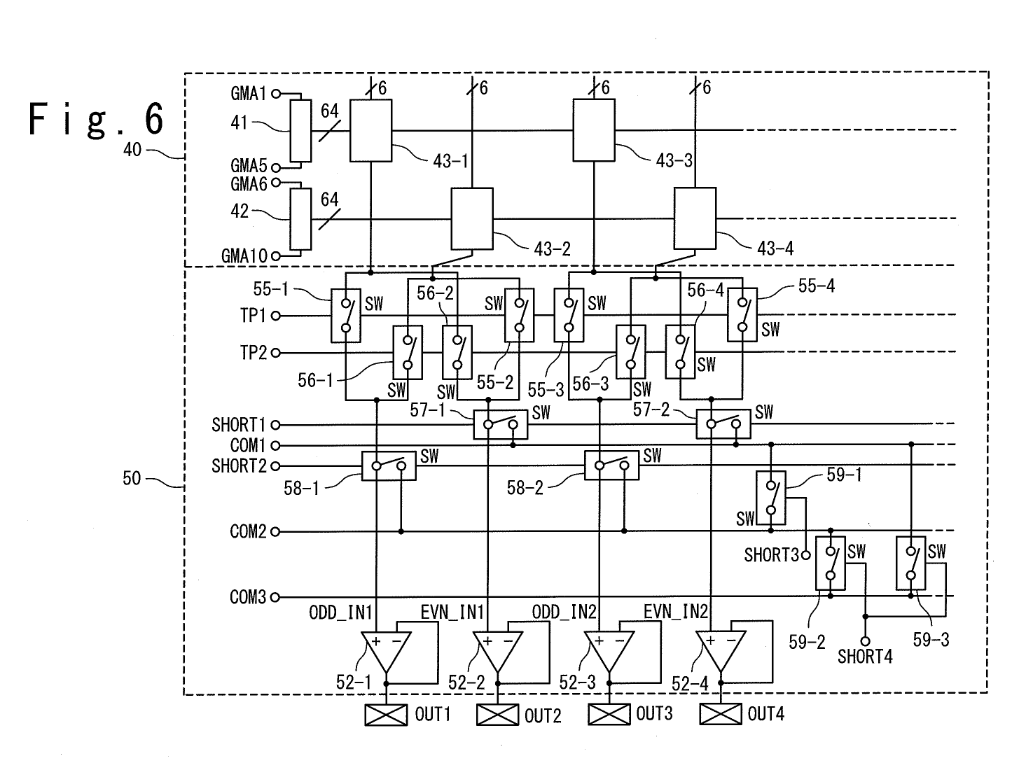

At first, the configuration of the driving circuit in this embodiment will be described. FIG. 6 is a circuit block diagram showing the configuration of the driving circuit in this embodiment. It should be noted that the configuration of the driving circuit in this embodiment is substantially the same as that of the driving circuit in the first embodiment. Thus, in the following description, the description is omitted for the same portions as the first embodiment, and the portions whose configurations are different are mainly described. Also, the following description will be described such that the similar symbols are given to the configuration similar to the first embodiment.

The driving circuit in this embodiment includes the D/A converter 40 and the output circuit 50, similarly to the first embodiment. The D/A converter 40 generates the positive and negative driving signals, respectively, which are applied to the liquid crystal elements in the LCD panel, on the basis of the image data supplied from the circuit of the former stage (not shown). The output circuit 50 switches the polarities of the driving signals, which are supplied from the D/A converter 40, for each column line.

The D/A converter 40 includes the resistor arrays 41 and 42 and the plurality of selectors 43-1 to 43-4. It should be noted that since the D/A converter 40 is similar to that of the first embodiment, its description is omitted. Also, FIG. 6 shows a part of the D/A converter 40 in order to simplify the description. The D/A converter 40 includes the selectors for the number of the column lines to be driven.

The output circuit 50 includes the output buffers 52-1 to 52-4, the switches 55-1 to 55-4, the switches 56-1 to 56-4, the switches 57-1 and 57-2, the switches 58-1 and 58-2 and the switch 59-1, and further includes switches 59-2 and 59-3. It should be noted that FIG. 6 shows a part of the output circuit 50 in order to simplify the description. The output circuit 50 includes the output buffers for the number of the column lines to be driven and the respective switches.

The output buffers 52-1 to 52-4, the switches 55-1 to 55-4, the switches 56-1 to 56-4, the switches 57-1 and 57-2, the switches 58-1 and 58-2 and the switch 59-1 are similar to those of the first embodiment, together with the their connections. Thus, their descriptions are omitted.

Through the switch 59-2, the common signal lines COM2 and COM3 are connected. The switch 59-2 receives a short-circuit control signal SHORT4, and its state is selected to be in the ON state or in the OFF state, in accordance with the short-circuit control signal SHORT4. When the switch 59-2 is in the ON state, the common signal lines COM2 and COM3 are connected. When the switch 59-2 is in the OFF state, the common signal lines COM2 and COM3 are opened.

Through the switch 59-3, the common signal lines COM1 and COM3 are connected. The switch 59-3 inputs the short-circuit control signal SHORT4, and its state is selected to be in the ON state or in the OFF state, in accordance with the short-circuit control signal SHORT4. When the switch 59-3 is in the ON state, the common signal lines COM1 and COM3 are connected. When the switch 59-3 is in the OFF state, the common signal lines COM1 and COM3 are opened.

In this embodiment, the voltage of the common signal line COM3 is held at the voltage (½)VDD2. When the switches 59-2 and 59-3 are in the ON state, each of the common signal lines COM1 and COM2 is connected to the common signal line COM3. Thus, the voltage of the common signal lines COM1 and COM2 have the voltage (½)VDD2.

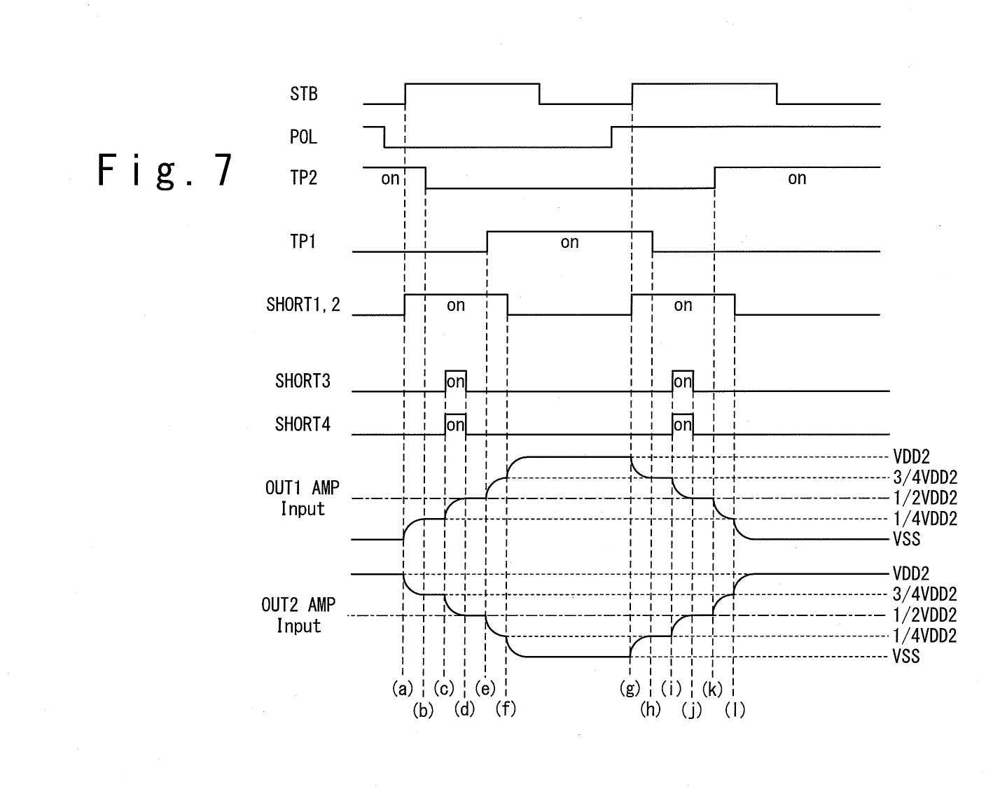

The operation method of the driving circuit in this embodiment will be described below. FIG. 7 is the timing chart showing the operation method of the driving circuit in this embodiment. It should be noted that the operation method of the driving circuit in this embodiment is substantially the same as that of the driving circuit in the first embodiment. Thus, in the following description, the description is omitted for the operation method whose configuration is the same as that of the first embodiment, and the portions whose operation method is different will be mainly described.

In FIG. 7, the short-circuit control signal SHORT4 is a signal for controlling the switches 59-2 and 59-3. The signals except for the short-circuit control signal SHORT4 are similar to those of the first embodiment. That is, the polarity control signal POL is a signal for controlling the polarity of the output buffer. The strobe signal STB is a signal for controlling the transfer of the image data, from the picture LSI (not shown) to the D/A converter 40. The switching control signal TP1 is a signal for controlling the switches 55-1 to 55-4, and the switching control signal TP2 is a signal for controlling the switches 56-1 to 56-4. Also, the short-circuit control signal SHORT1 is a signal for controlling the switches 57-1 and 57-2, and the short-circuit control signal SHORT2 is a signal for controlling the switches 58-1 and 58-2. The short-circuit control signal SHORT3 is a signal for controlling the switch 59-1. The symbol OUT1 AMP INPUT indicates a drive voltage level in the input terminal of the output buffer 52-1. The symbol OUT2 AMP INPUT indicates the drive voltage level in the input terminal of the output buffer 52-2.

Also, the following description is assumed that the output buffer 52-1 is driven from the negative drive voltage GMA10 to the positive drive voltage GMA1, similarly to the first embodiment. Also, simultaneously, the case is assumed that the output buffer 52-2 whose output polarity of the drive voltage differs from that of the output buffer 52-1 is driven from the positive drive voltage GMA10 to the negative drive voltage GMA1. It should be noted that the following description will be given under the assumption of GMA1≈VDD2 and GMA10≈VSS.

In the operation method of the driving circuit in this embodiment, (c), (d), (i) and (j) in FIG. 7 differ from those of the first embodiment. At first, the following operation method is carried out in (c) and (d) in FIG. 7.

At (c), the short-circuit control signal SHORT3 becomes the high level, and the switch 59-1 is turned on. Also, simultaneously, the short-circuit control signal SHORT4 becomes the high level, and the switches 59-2 and 59-3 are turned on. At this time, the switching control signal TP2 is still in the low level, and the switches 56-1 to 56-4 are in the OFF state. The switching control signal TP1 is still in the low level, and the switches 55-1 to 55-4 are in the OFF state. The short-circuit control signals SHORT1 and SHORT2 are still in the high level, and the switches 57-1 and 57-2, 58-1, and 58-2 are in the ON state.

Since the switch 59-1 is turned on, the common signal lines COM1 and COM2 are connected. Thus, the input terminals of the output buffers 52-1 to 52-4 are short-circuited. Moreover, since the switches 59-2 and 59-3 are turned on, the common signal lines COM1 and COM2 are connected to the common signal line COM3. The voltage of the common signal line COM3 is held at the voltage (½)VDD2, and the common signal lines COM1 and COM2 are connected to the common signal line COM3. Thus, their voltages are set to the voltage (½)VDD2. Therefore, the output buffers 52-1 to 52-4 are driven with the voltage (½)VDD2.

Next, at (d), the short-circuit control signal SHORT3 becomes the low level, and the switch 59-1 is turned off. Also, the short-circuit control signal SHORT4 becomes the low level, and the switches 59-2 and 59-3 are turned off. At this time, the switching control signal TP2 is still in the low level, and the switches 56-1 to 56-4 are in the OFF state. The switching control signal TP1 is still in the low level, and the switches 55-1 to 55-4 are in the OFF state. The short-circuit control signals SHORT1 and SHORT2 are still in the high level, and the switches 57-1 and 57-2, 58-1, and 58-2 are in the ON state.

In this state, in the common signal lines COM1 and COM2, their voltages are still held at the voltage (½)VDD2. Thus, the output buffers 52-1 to 52-4 are driven with the voltage (½)VDD2.

In succession, at (i) and (j) in FIG. 7, the following operation methods are carried out.

At (i), the short-circuit control signal SHORT3 becomes the high level, and the switch 59-1 is turned on. Also, the short-circuit control signal SHORT4 becomes the high level, and the switches 59-2 and 59-3 are turned on. At this time, the switching control signal TP2 is still in the low level, and the switches 56-1 to 56-4 are in the OFF state. The switching control signal TP1 is still in the low level, and the switches 55-1 to 55-4 are in the OFF state. The short-circuit control signals SHORT1 and SHORT2 are still in the high level, and the switches 57-1 and 57-2, 58-1, and 58-2 are in the ON state.

Since the switch 59-1 is turned on, the common signal lines COM1 and COM2 are connected. Thus, the input terminals of the output buffers 52-1 to 52-4 are short-circuited. Moreover, since the switches 59-2 and 59-3 are turned on, the common signal lines COM1 and COM2 are connected to the common signal line COM3. In the common signal line COM3, its voltage is held at the voltage (½)VDD2, and the common signal lines COM1 and COM2 are connected to the common signal line COM3. Thus, their voltages are set to the voltage (½)VDD2. Therefore, the output buffers 52-1 and 52-2 are driven with the voltage (½)VDD2.

Next, at (j), the short-circuit control signal SHORT3 becomes the low level, and the switch 59-1 is turned off. Also, the short-circuit control signal SHORT4 becomes the low level, and the switches 59-2 and 59-3 are turned off. At this time, the switching control signal TP2 is still in the low level, and the switches 56-1 to 56-4 are in the OFF state. The switching control signal TP1 is still in the low level, and the switches 55-1 to 55-4 are in the OFF state. The short-circuit control signals SHORT1 and SHORT2 are still in the high level, and the switches 57-1 and 57-2, 58-1, and 58-2 are in the ON state.

In this state, the common signal lines COM1 and COM2 still approximately hold the voltage (½)VDD2. Thus, the output buffers 52-1 and 52-2 are driven with the voltage (½)VDD2.

The above description is the description of the operation method of the driving circuit in this embodiment. Except the above (c), (d), (i) and (j), the short-circuit control signal SHORT4 is in the low level, and the other operation methods are not influenced. Thus, the operation methods except the above operation method are similar to those of the first embodiment.

Until now, the driving circuit in this embodiment has been described. According to the driving circuit in this embodiment, in the driving circuit in this embodiment, through the switches 59-2 and 59-3, the common signal lines COM1 and COM2 are connected to the common signal line COM3. In the common signal line COM3, its voltage is held at the voltage (½)VDD2. In the driving circuit in this embodiment, through the common signal line COM3, the common signal lines COM1 and COM2 are forcedly set to the voltage (½)VDD2. Thus, the voltages of the common signal lines COM1 and COM2 can be set to the voltage (½)VDD2 surely in a short time. Therefore, the drive time of the output buffer can be further reduced.

In this way, the driving circuit of the present invention can continuously change the drive voltage to the output buffer. Thus, the drive voltage can be always driven for the output buffer, without setting the input terminal of the output buffer to a high impedance state. Therefore, the drive time of the output buffer can be reduced, and the output delay of the output buffer can be improved.

As mentioned above, the present invention has been described by referring to the embodiments. However, the present invention is not limited to the above-mentioned embodiments. The various modifications that can be understood by one skilled in the art can be made to the configurations and details of the present invention within the scope of the present invention.

1. A driving circuit comprising:
output buffers provided to drive first and second groups of data lines, which are connected with pixels of a display panel, with drive voltage signals supplied to input terminals of said output buffers, respectively;
first and second common portions;
a first short-circuiting section provided for each of the data lines of said first group to connect the input terminal of a corresponding one of said output buffers for said first group of data lines to said first common portion in response to a first connection control signal; and
a second short-circuiting section provided for each of the data lines of said second group to connect the input terminal of a corresponding one of said output buffers for said second group of data lines to said second common portion in response to a second connection control signal.

2. The drive circuit according to claim 1, further comprising:
a third short-circuiting section configured to connect said first and second common portions in response to a third connection control signal.

3. The drive circuit according to claim 2, further comprising:
a third common portion in addition to said first and second common portions; and
a fourth short-circuiting section configured to connect said first, second and third common portions in response to a fourth connection control signal.

4. The drive circuit according to claim 2, further comprising:
a gradation voltage generating section configured to generate first voltage signals of a first polarity, and second voltage signals of a second polarity different from the first polarity;
a voltage selecting section configured to select first drive voltage signals from said first voltage signals and second drive voltage signals from said second voltage signals based on an image data for one line of the display panel; and
a switching section configured to output said first and second drive voltage signals as drive voltage signals in response to first and second switching control signals such that said first and second drive voltage signals are outputted to said output buffers connected to said first and second group of data lines, or said first and second drive voltage signals are outputted to said output buffers connected to said second and first group of data lines, respectively.

5. The drive circuit according to claim 4, wherein said first and second switching control signals are activated during periods different from each other.

6. The drive circuit according to claim 5, wherein said first and second connection control signals are activated during a short-circuit period during which at least one of said first and second switching control signals is inactivated.

7. The drive circuit according to claim 6, wherein said third connection control signal is activated during a part of the short-circuit period during which said first and second switching control signals are both inactivated.

8. The drive circuit according to claim 6, further comprising:
a third common portion in addition to said first and second common portions; and
a fourth short-circuiting section configured to connect said first, second and third common portions in response to a fourth connection control signal,
wherein said third and fourth connection control signals are activated during a part of the short-circuit period during which said first and second switching control signals are both inactivated.

9. A driving method comprising:
driving by output buffers, first and second groups of data lines, which are connected with pixels of a display panel, with drive voltage signals supplied to input terminals of said output buffers, respectively;
connecting the input terminal of each of said output buffers for said first group of data lines to a first common portion in response to a first connection control signal; and
connecting the input terminal of each of said output buffers for said second group of data lines to a second common portion in response to a second connection control signal.

10. The drive method according to claim 9, further comprising:
connecting said first and second common portions in response to a third connection control signal.

11. The drive method according to claim 10, further comprising:
connecting said first, second and third common portions in response to a fourth connection control signal.

12. The drive method according to claim 10, further comprising:
generating first voltage signals of a first polarity, and second voltage signals of a second polarity different from the first polarity;
selecting first drive voltage signals from said first voltage signals and second drive voltage signals from said second voltage signals based on an image data for one line of the display panel; and
outputting said first and second drive voltage signals as drive voltage signals in response to first and second switching control signals such that said first and second drive voltage signals are outputted to said output buffers connected to said first and second group of data lines, or said first and second drive voltage signals are outputted to said output buffers connected to said second and first group of data lines, respectively.

13. The drive method according to claim 12, further comprising:
activating said first and second switching control signals during periods different from each other.

14. The drive method according to claim 13, further comprising:
activating said first and second connection control signals during a short-circuit period during which at least one of said first and second switching control signals is inactivated.

15. The drive method according to claim 14, further comprising:
activating said third connection control signal during a part of the short-circuit period during which said first and second switching control signals are both inactivated.

16. The drive method according to claim 14, further comprising:
activating said third connection control signal and a fourth connection control signal during a part of the short-circuit period during which said first and second switching control signals are both inactivated; and
connecting said first and second common portions and a third common portion in response to the fourth connection control signal.
